(19) United States
(12) Patent Application Publication
(10) Pub. No.: US 2025/0328955 A1
(43) Pub. Date: Oct. 23, 2025

(54) ARTIFICIAL INTELLIGENCE-INITIATED GENERATION OF CLOUD-CREATED TOKENS WITH CONTROLS

(71) Applicant: Capital One Services, LLC, McLean, VA (US)

(72) Inventors: Jackson Macomber, Henrico, VA (US); Jeffrey Carlyle Wieker, Falls Church, VA (US); Austin Fuglestad, Frederick, VA (US); Charlie Gene Size, Arlington, VA (US)

(73) Assignee: Capital One Services, LLC, McLean, VA (US)

(21) Appl. No.: 19/184,102

(22) Filed: Apr. 21, 2025

Related U.S. Application Data
(60) Provisional application No. 63/637,282, filed on Apr. 22, 2024.

(51) Int. Cl. G06Q 40/02

(52) U.S. Cl. CPC G06Q 40/02

(57) ABSTRACT

Techniques for artificial intelligence (AI) initiated generation of tokens with controls are provided. Systems and methods disclosed herein utilize cloud-based systems integrated with a virtual card platform to deliver controllable virtual card payment methods to a user device's secure element for in-personal or terminal payments. Systems and methods for management of virtual card numbers are also provided.

### CROSS-REFERENCE TO RELATED APPLICATION

This application claims the priority of U.S. Provisional Patent Application No. 63/637,282, filed on Apr. 22, 2024, the contents of which are incorporated herein by reference in their entirety.

### BACKGROUND

Credit card usage has become virtually ubiquitous among consumers with respect to purchases made with merchants in person or online. With increased usage of credit cards has come increased rates of security breaches and theft of user credit card numbers. When a user's credit card number, or personal account number (PAN), has been stolen or otherwise compromised, it can cause significant financial burden on the card holder as well as other issues, including consuming time contacting their card issuer to cancel their card and obtain a new one, or contacting merchants to cancel a purchase. Some methods of reducing card number theft have been introduced, but some of these methods lack customization capabilities and may not be suitable to safeguard the PAN of the cardholder in some situations. As such, improved systems are needed.

### SUMMARY

In some aspects, the techniques disclosed herein relate to a virtual card number (VCN) management system, comprising: a processor circuit in data communication with an artificial intelligence (AI) system, wherein the AI system: generates one or more VCNs, provisions, to one or more user devices, each of the one or more VCNs, monitors a usage of each of the one or more VCNs, identifies at least one of the one or more VCNs for removal, and responsive to an identification of at least one of the one or more VCNs for removal, transmits, to at least one of the one or more user devices, a signal to remove the at least one of the one or more VCNs.

In some aspects, the techniques disclosed herein relate to a method for virtual card number (VCN) management, comprising: generating, by an artificial intelligence (AI) system in data communication with a processor circuit, one or more VCNs; provisioning, by the AI system to one or more user devices, each of the one or more VCNs; monitoring, by the AI system, a usage of each of the one or more VCNs; identifying, by the AI system, at least one of the one or more VCNs for removal; and responsive to an identification of at least one of the one or more VCNs for removal, transmitting, by the AI system to at least one of the one or more user devices, a signal to remove the at least one of the one or more VCNs.

In some aspects, the techniques disclosed herein relate to a non-transitory computer readable medium comprising instructions implementing an artificial intelligence (AI) system, wherein, when executed by a processor circuit, cause the processor circuit to perform procedures comprising: generating one or more virtual card numbers (VCNs); provisioning, to one or more user devices, each of the one or more VCNs; monitoring a usage of each of the one or more VCNs; identifying at least one of the one or more VCNs for removal; and responsive to an identification of at least one of the one or more VCNs for removal, transmitting, to at least one of the one or more user devices, a signal to remove the at least one of the one or more VCNs.

Further features of the disclosed systems and methods, and the advantages offered thereby, are explained in greater detail hereinafter with reference to specific example embodiments illustrated in the accompanying drawings.

### BRIEF DESCRIPTION OF THE SEVERAL VIEWS OF THE DRAWINGS

In order to facilitate a fuller understanding of the present invention, reference is now made to the attached drawings. The drawings should not be construed as limiting the present invention but are intended only to illustrate different aspects and embodiments of the invention. To easily identify the discussion of any particular element or act, the most significant digit or digits in a reference number refer to the figure number in which that element is first introduced.

FIG. 1A illustrates an example network diagram of an NFC token system in accordance with one embodiment.

FIG. 1B illustrates block diagrams of an example user device and issuer server in accordance with one embodiment.

FIG. 1C illustrates a block diagram of an example data source in accordance with one embodiment.

FIG. 2 illustrates a network diagram of a VCN management system in accordance with one embodiment.

FIG. 3 illustrates a network diagram of a multi-user network in accordance with one embodiment.

FIG. 4 illustrates a network diagram of a feature provisioning system in accordance with one embodiment.

FIG. 5 illustrates an example contactless card in accordance with one embodiment.

FIG. 6 illustrates a transaction card component in accordance with one embodiment.

FIG. 7 illustrates a system in accordance with one embodiment.

FIG. 8 illustrates an apparatus in accordance with one embodiment.

FIG. 9 illustrates an artificial intelligence architecture in accordance with one embodiment.

FIG. 10 illustrates an artificial neural network in accordance with one embodiment.

FIG. 11 illustrates a method for VCN management in accordance with one embodiment.

FIG. 12 illustrates a sequence diagram of an operation for VCN management in accordance with one embodiment.

FIG. 13 illustrates a computing architecture in accordance with one embodiment.

### DETAILED DESCRIPTION

Embodiments disclosed herein provide techniques for artificial intelligence (AI) or machine learning (ML) initiated generation of cloud created near field communication (NFC) tokens with controls. An NFC token is a data structure or message within which a virtual card number (VCN) can be transmitted to a device for use in making purchases. The VCN is associated with a user's credit card and can be used to transmit to merchants, instead of the actual credit card number (PAN) of the user's credit card. By using this technique, the actual credit card number of the user is kept private, or secret, and is therefore not shared in a way that it can be compromised as discussed above. In this scenario, a user device is sent the VCN and it is added to the user's digital wallet on their device (e.g., a mobile device such as a smart phone) as a mobile payment method. The user can then pay at merchants in-person using an NFC exchange (e.g., “tap to pay”) via their mobile device, or online using similar functionality.

There are many different ways to use VCNs, and several types of controls are available. However, there are no predictive solutions for combinations of controls to meet various needs. The present disclosure provides for an intelligent (AI) concierge-type service that has the ability to aggregate user data, understand behavioral patterns of primary and authorized users, and consume or create prompts to provide a VCN with the necessary controls in real-time. The AI model will also be able to learn market trends, understand inventory levels, and predict pricing fluctuations for Business applications.

Advantageously, embodiments disclosed herein provide AI and ML (AI/ML) techniques the utilize cloud-based systems integrated with a virtual card platform to deliver controllable virtual card payment methods to a user device's NFC secure element for in-personal or terminal payments. The systems and techniques described herein leverage data from many sources, stores and updates this data based on evolving customer activity. The systems described herein then run the collected data through an ML algorithm to drive an AI backend system that helps generate a controllable payment method and automatically delivers the payment method (e.g., VCN) to a secure element on the user's NFC capable device (e.g., user device 108).

The techniques described herein provide a meaningful improvement in the technological field of secure payment systems. Namely, the techniques improve the security of the PAN itself and adds an extra layer of protection to prevent fraud and theft. Additionally, the techniques described herein provide additional flexibility in VCN generation and usage.

As these VCNs are generated, they may be used over a period of time, or unused completely. In either case, VCNs may become stagnant over time (e.g., they were either never used since generation or they have not been used in some time) such that it may be beneficial to remove them to clear up memory space. For example, if a VCN is created for a one-time purchase at a specific location and likely will never be used again, it may be desirable to clean-up or remove these VCNs that are no longer being utilized on the user device. These embodiments improve technology by automatically freeing up memory space and allowing digital payment systems on the user device to operate more efficiently because they are not burdened by unnecessary memory utilization.

In some other embodiments, a VCN or NFC token can be provisioned by the AI/ML system to a second user's device. For example, a parent's account may provision a VCN to their child's mobile device, or to another relative. In another embodiment, the VCN can be added to the second user's device by the user associated with the contactless card tapping their card to the second user's mobile device. In this way, the VCN can be added to the second user's digital wallet.

In still other embodiments, in-person marketing or a discount can be applied to a VCN or gift card provisioned to a user's mobile device.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

Further, the described features and advantages of the embodiments may be combined in any suitable manner. One skilled in the art will recognize that the embodiments may be practiced without one or more of the features or advantages of an embodiment, and one skilled in the art will recognize the features or advantages of an embodiment can be interchangeably combined with the features and advantages of any other embodiments. In other instances, additional features and advantages may be recognized in certain embodiments that may not be present in all embodiments.

In the drawings and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all operations illustrated in a logic flow may be required in some embodiments. In addition, a logic flow may be implemented by a hardware element, a software element executed by a processor, or any combination thereof. The embodiments are not limited in this context.

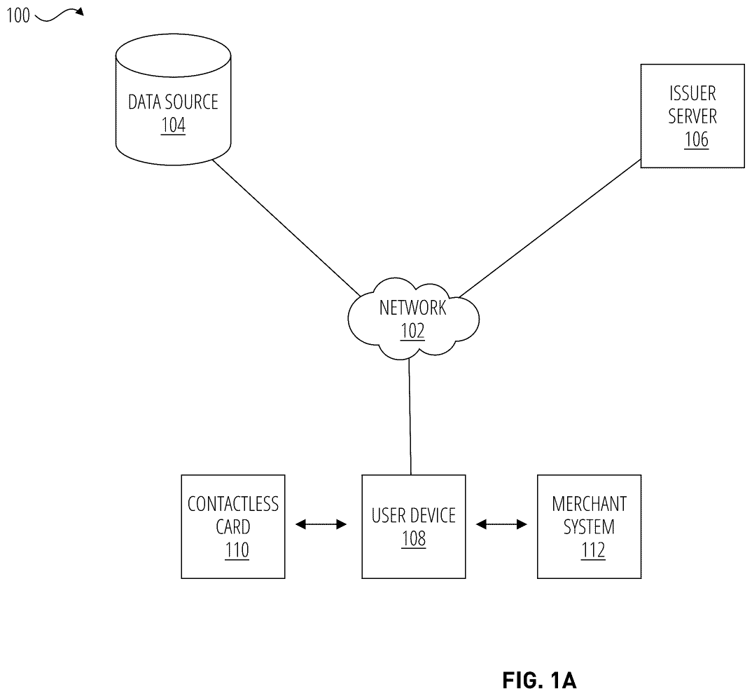

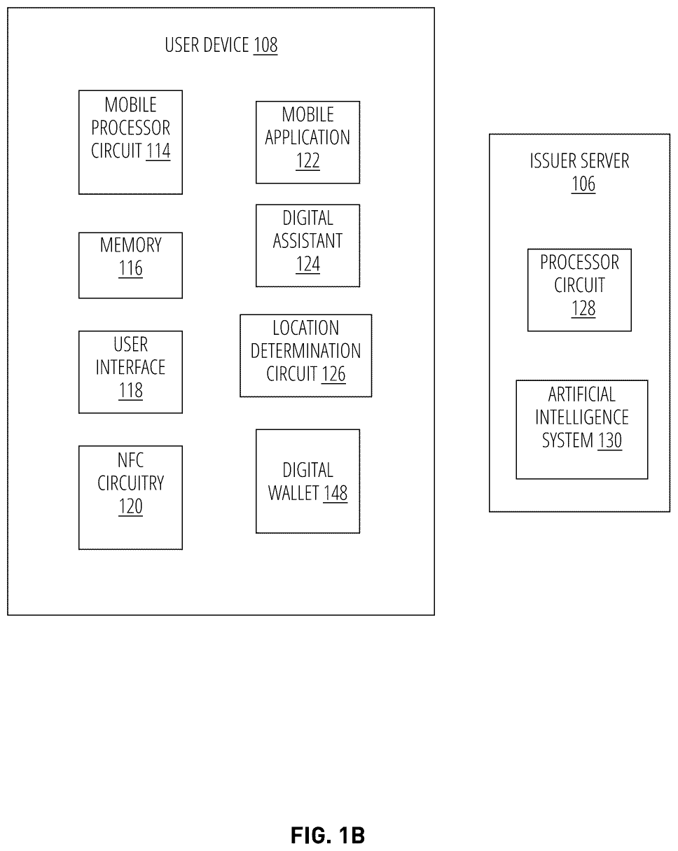

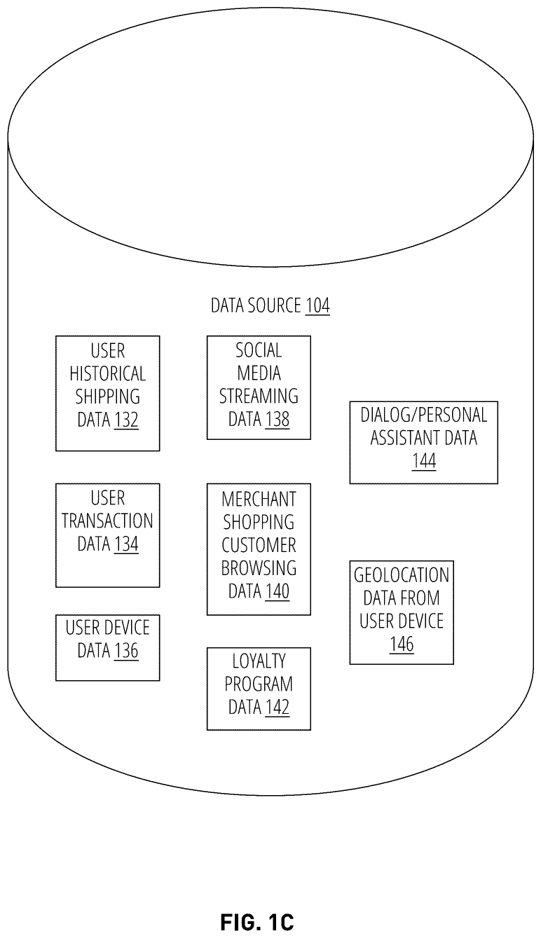

FIG. 1A illustrates a network diagram of an example VCN generation system 100 according to some embodiments of the present disclosure. Namely, in some embodiments, the VCN generation system 100 includes a network 102 to connect a data source 104, an issuer server 106, and a user device 108. The data source 104 can include a database of data captured over time and is described in more detail in FIG. 1B. The issuer server 106 is associated with a card issuer that issued a contactless card 110 associated with the user device 108. The issuer server 106 may be a server operated and controlled by the issuer of the contactless card 110 or the issuer server 106 can be a third party system that performs actions described herein on behalf of the issuer. The user device 108 may be a mobile device or any other suitable device described in more detail in FIG. 1B. For the purposes of the below description, the user device 108 is a mobile device such as a smart phone, iPhone, or smart phone operating an Android based operating system.

The user device 108 and the contactless card 110 are associated with a user that has a user account with the issuer server 106. The user account can include, for example, a credit card account with the issuer server 106. The user device 108 is configured to share location, transaction, purchase, and other historical data with the data source 104 which stores the processes the data to share with the issuer server 106.

In some embodiments, the user may attempt to pay for goods or services at a merchant system 112 using their user device 108 via NFC exchange. The user will tap their user device 108 to the merchant system 112 and the digital wallet of their user device 108 will use a VCN provided to it by the issuer server 106 as described herein.

FIG. 1B illustrates block diagrams illustrating the user device 108 and the issuer server 106. For example, the issuer server 106 includes a processor circuit 128 configured to operate and execute an artificial intelligence system 130 stored thereon. In some embodiments, the artificial intelligence system 130 may be stored in memory contained by the issuer server 106. In other embodiments the artificial intelligence system 130 may be stored externally to the issuer server 106, such as in another server (e.g., a cloud-based server) or other device (e.g., a user device) in data communication with the issuer server 106. The issuer server 106 may be a cloud-based server that provides one or more VCNs to the user device 108 via network 102. The issuer server 106 uses one or more AI and/or ML techniques to provide and perform services described here. For example, when referring to automated VCN provisioning herein, AI techniques likely aid in this automated functionality. While ML techniques are also utilized in automated VCN provisioning, the ML techniques are also geared to being trained on data and information collected about the user, user transactions and purchases and other data described herein. The data collection and training of the artificial intelligence system 130 is used by the AI techniques to automatically provision VCNs to the user device 108.

The user device 108 may include any suitable computing device. For example, the user device 108 may include a smart phone, cell phone, mobile phone, iphone, Android phone, tablet, iPad, personal computer, tablet PC, server computer, wearable device (e.g., smart watch, smart ring, smart necklace or lanyard, clip-on smart device, etc.), or any other suitable computing device. For the purposes of the following discussion, the user device 108 will be a mobile device such as a smart phone with NFC capability.

In some embodiments, the user device 108 includes a mobile processor circuit 114 configured to execute most of the steps and actions described herein that are performed by the user device 108. The user device 108 further includes memory 116 for storing the VCN thereon. The memory 116 also includes executable instructions to perform various functions described herein. The user device 108 further includes a user interface 118, including one or more buttons, a graphic user interface (GUI), a selectable screen (such a mobile device screen) which can accept user input via the user tapping the screen, swiping with their finger(s), or otherwise indicating a selection on the user interface 118.

In some embodiments, the user device 108 includes NFC circuitry 120 to perform payments and transactions using the VCN with the merchant system 112 in FIG. 1A. The user device 108 further includes a mobile application 122 to communicate with the issuer server 106 and receive the VCN(s) therefrom. The mobile application 122 can also be used to share data with the data source 104. The user device 108 can further include a digital assistant 124. The digital assistant 124 can include any digital assistant such as a verbal activated digital assistant. Any suitable digital assistant 124 such as digital assistants provided by Apple, Amazon, Google, or any other suitable digital assistant can be utilized.

The user device 108 further includes a location determination circuit 126. The location determination circuit 126 can include a global positioning system (GPS) circuit, antenna, Wi-Fi antenna and system, or any other system thereon which can help determine a location of the user device 108 and therefore the user thereof. For example, the location determination circuit 126 can help determine if the user device 108 and the user are located in a specific store, city, town, country, mall, merchant location, or any other suitable location. The user device 108 further includes a digital wallet 148 for storing the VCN received from the issuer server 106 and for exchanging NFC data with the merchant system 112 and for paying for goods and services at the merchant system 112 using the VCN(s) sent by the issuer server 106.

FIG. 1C illustrates the data source 104, including some of the data it might receive from the user device 108 (any other user devices in the network 102) and store therein. For example, the data source 104 may receive and store user historical shipping data 132 and user transaction data 134 for the user. The user historical shipping data 132 indicates where the user might live and where the user might shop. The user transaction data 134 indicates where the user might shop and what the user might have bought in the past. The user transaction data 134 further includes data related to payment methods, transaction times, and other aspects of transactions. The data source 104 can further include user device data 136 which can indicate user device 108 location data. This can indicate where a user shops, including specific stores and locations. The data source 104 can further include social media streaming data 138 which indicate advertisements the user interacts with or products and services the user interacts with on social media advertising.

The data source 104 can further include merchant shopping customer browsing data 140, which can indicate merchant purchase and browsing history by the user. The data source 104 can further include loyalty program data 142 such as credit card loyalty programs, merchant loyalty programs, travel, hotel, and other loyalty programs. This information can indicate what kinds of purchases the user has executed as well as what kinds of goods and services, as well as merchants, the user may be interested in. The data source 104 can further include dialog/personal assistant data 144 which may provide data from verbal discussions with the digital assistant that indicate purchasing needs (e.g., grocery list or to do list) or desires (e.g., wish list, gift list, etc.). The data source 104 may also receive geolocation data from user device 146 directly as the user device 108 moves around.

In some embodiments, the data source 104 can further include browsing data from the user, including autofill data for addresses and names. The data source 104 can further include other data that might be stored in the digital wallet 148, such as boarding passes, train tickets, amusement park passes, museum passes, or forms of identification. The data source 104 can further include human data from the user, including hair color, body proportions, and other features of the user. The data source 104 can further include data on the user device 108, such as what type of device user device 108 is (e.g., iphone, Android phone, personal computer, etc.). The data source 104 can further include web browser extension data from the user, including any shopping extension or payment method extension (e.g., gaming system extension, issuer-based shopping extension, etc.). In some embodiments, the data source 104 can further include multiple profile data, such as data regarding the user buying items for someone else or another user account. The data source 104 can further include travel data associated with the user or user device 108, including locations to which the user traveled and dates on which the user traveled. In some embodiments, the data source 104 includes merchant risk data, including how risky a merchant is as assessed by a central authority.

Using this data, the artificial intelligence system 130 of the issuer server 106 can analyze the data in the data source 104 and determine one or more VCNs to be provisioned to the user device 108 as described herein. The artificial intelligence system 130 can be trained on the data stored in the data source 104 and then the artificial intelligence system 130 makes predictions and decisions based on analysis of the data.

The artificial intelligence system 130 understands natural language prompts and determines the best VCN solution for the prompt. It has access to Primary and AU devices and behavioral history and can push provision VCNs to devices, such as user device 108, and to the users' digital wallets, such as digital wallet 148. When a primary user prompts the service with a use case, the service compares the use case to a set of rules that include possible combinations of controls. It then will call an API to determine if the appropriate VCN has already been created and retrieve it. If it does not already exist it will call a create API to create the appropriate VCN. It will then push provision the VCN to the necessary device, such as user device 108, or payment platform for the use case. Leveraging financial data and learnings from customer behavior, the artificial intelligence system 130 will also prompt the Primary User with VCN applications relevant to them. This could take the form of budgeting prompts for consumer accounts, or predictive purchasing based on best pricing for business accounts. Some of the VCN controls contemplated herein include locking the VCN from use, unlocking the VCN, auto-lock (time-based), auto-unlock (time-based), merchant binding, merchant category binding, unbound, one-time use vs multi-use, minimum/max spending thresholds, provisioning to digital wallets, project based, proximity based authority, and autofill.

In some embodiments, automated virtual card controls are recommended or automatically applied by the artificial intelligence system 130, based on a machine learning model. The artificial intelligence system 130 and model leverages data such as customer transaction history (e.g., types of transactions (e.g., online, in-store), transaction amounts, merchants, frequency, and any fraud history), customer preferences and behavior (e.g., previous choices for virtual card controls, response to past recommendations, and any expressed preferences regarding security and convenience, and anonymized data from other customers), and transaction context (e.g., merchant name and category, transaction size, recurrence (e.g., one-time vs subscription), and relevant time-based patterns (e.g., holiday shopping)).

In one example embodiment, the artificial intelligence system 130 can analyze the historical data in the data source 104 as well as the current location data of the user device 108 and send a message to the user device 108, prompting the user to authorize creation of a VCN for use by the user and the user device 108 to pay for merchandise or services based on the location of the user device 108. In this way, the artificial intelligence system 130 is to analyze the historical data in the data source 104 and the current location data of the user device 108 and make predictions about a possible upcoming spend moment. For example, the current location data (geolocation) of the user device 108 may indicate that the user has been located inside a given store for a period of time. The artificial intelligence system 130 will detect this stationary period and then send a prompt to the user device 108 to display on the user interface 118 to authorize the creation of an NFC payment token that includes a VCN to be used at checkout to pay for the user's goods and services.

An example prompt might include a question posed on the GUI of the user device 108 to the user such as “Do you want to use a VCN for your Nike purchase?” The GUI will then allow for a selection of approval or disapproval (e.g., “YES” or “NO” buttons selectable on the GUI) by the user of the user device 108. The VCN will either already be created by the artificial intelligence system 130 or will be created in response to the user answering in the affirmative, and, in response to the user answering on the GUI in the affirmative, the new VCN will be provisioned to the user device 108. In other words, the artificial intelligence system 130 will send the VCN in an NFC token message to the user device 108, the user device 108 will receive the VCN and add the VCN to the digital wallet 148. The user could then tap their user device 108 to a merchant system 112 within the store and the digital wallet 148 will perform an NFC exchange with the merchant system 112 to send the VCN to the merchant system 112 to pay for the user's goods or services.

In another example embodiment, the process of generating the VCN is completely automated and no prompt is given to the user to determine whether a VCN should be generated. Instead, the VCN will be automatically generated by the artificial intelligence system 130. In this case, the artificial intelligence system 130 is trained from the historical data from the data source 104 and based on the training and the present location of the user device 108, the artificial intelligence system 130 will recognize the upcoming need for a VCN to be generated and available for use by the user. The artificial intelligence system 130 will then automatically create the VCN based on the location of the user device 108 and send the VCN to the user device 108. In some cases, the artificial intelligence system 130 will also consider transaction history data received from the issuer server 106 as the transaction history relates to a merchant, as well as perform predictive modeling in lieu of or in combination with location data. The message sent to the user device 108 from the issuer server 106 causes the new VCN to be surfaced to the top of the digital wallet 148 of the user device 108 for the next checkout by the user in a tap to pay scheme.

In some embodiments, the user may set certain controls or provide certain control settings for any VCNs generated by the artificial intelligence system 130. For example, before the VCN is created, the user can set a spending limit, the user can bind the VCN to a particular merchant (e.g., automatic VCNs are only usable at “X” store), the user can indicate the number of uses for an automatically generated VCN (e.g., one-time use, multiple uses, indefinite, etc.). The user can set these limitations for VCNs created via prompt as well. For example, in the mobile application 122, the above settings, as well as others, may be adjustable by the user, and then the mobile application 122 sends the user settings which indicate the controls for the VCNs to the issuer server 106 and the artificial intelligence system 130 generates the VCN for the user with the settings or controls in place.

In another example embodiment, the user will prompt the artificial intelligence system 130 to generate the VCN for the user. That is, using the mobile application 122, the user will request from the artificial intelligence system 130 a VCN to be created. In another example, the user can use a text message to communicate with the artificial intelligence system 130 to generate the VCN. In another example, the user can use the digital assistant 124 to prompt the artificial intelligence system 130 to create a VCN and then the user device 108 will retrieve the VCN from the artificial intelligence system 130. The user can set controls in the mobile application 122 or in the message or voice instruction to the digital assistant 124. The artificial intelligence system 130 will then generate the VCN with the controls and setting applied. For example, the user may use the digital assistant 124 to verbally request “Hey Siri, can you generate a one-time-use virtual card/VCN for my Walmart purchase?” The artificial intelligence system 130 will receive that request from the digital assistant 124 and generate a VCN that is for one time purchase at Walmart.

Controls discussed herein can be manually set in the mobile application 122 by the user. However, cardholders prioritize efficiency when shopping and do not always possess the resilience to enable controls that could optimize or secure their online transactions. As such, in some other embodiments, the artificial intelligence system 130 can determine and provide controls to set on the VCN provisioned to the digital wallet 148. The VCN generation system 100 uses intelligence to predict and automatically apply the virtual card controls that help the cardholder optimize their shopping experience.

For example, the artificial intelligence system 130 can be trained using the data source 104 and various data therein. Based on this training, including previous controls applied, the artificial intelligence system 130 can identify certain controls and provision controls that will provide the safest VCN type with controls that help prevent overspending, fraud, theft, use at the wrong merchant, as well as other controls to improve the overall experience for the user associated with the user device 108 and contactless card 110. In some cases, the artificial intelligence system 130 can further be used to detect fraud and recommend VCN types and appropriate controls therefor. For example, if fraud is detected and a new card needs to be sent to the user, a VCN can be sent to the user device 108 so that the user can still make purchases on known devices (e.g., the user device 108) while the new card is being provisioned and sent to the user.

In another example, a VCN can be auto-locked (e.g., prevent from use) for subscription services, and the auto-lock removed (e.g., auto-unlocked) just in time for the next month's bill. The lock can then be reapplied. Some other examples include enabling a single customer VCN for a merchant that is known to be risky.

To accomplish the above controls being assigned or put in place, the VCN generation system 100 supplies a virtual card to a user device 108 via an API call from a front-end system. VCN generation system 100 then receives the request and supplies a virtual card to the front-end requesting system. Merchant system 112 then accepts the virtual card for payment. The back-end issuer server 106 detects metadata about the transaction and then the trained artificial intelligence system 130 makes a recommendation on VCN card controls. The VCN controls can be automatically set on the digital wallet 148 or offered to the user on the user interface 118 to be manually set by the user.

Although FIGS. 1A-1C only depict a single user device 108, multiple user devices can be present and the artificial intelligence system 130 can provision VCNs for multiple user devices at the same time.

In some embodiments, as discussed herein, the systems and techniques of the present disclosure leverage an ML recommendation model. The process below is laid out below helps to predict the optimal set of control features (e.g., locking the card, binding it to a specific merchant, setting a time period during which the card is active, or making it single-use) for a virtual card number for each transaction to enhance security and customer convenience. The data collected above for the data source 104 with respect to transaction history, customer history, and transaction context is used in feature engineering.

Feature engineering includes determining derived features that could influence the model's predictions. For example, transaction features (e.g., including merchant category codes (MCC), transaction amount, online vs. physical, and domestic vs. international features), customer features (e.g., historical preference for controls, frequency of virtual card use, fraud experience, etc.), and temporal features (e.g., time of day, day of the week, seasonality aspects) all can influence the ML model's predictions and are determined. Next, the process includes model selection. VCN controls fits a multi-label classification approach where each control feature (locking, merchant binding, single use, etc.) can be considered a label, and transactions can have multiple labels. Decision trees, random forests, or neural networks could be appropriate depending on the complexity of the data and relationships.

Next, after the model is selected, the process moves into model training. Some aspects of the ML model training process include supervised learning. With a labeled dataset where past transactions are tagged with the controls applied (or should have been applied for optimal outcomes), the model can learn to associate transaction features and customer behavior with the appropriate controls. A feedback loop can be provided to the learning process wherein the learning process incorporates customer feedback on the recommendations (accepted, rejected, modified) can refine the model's accuracy and relevance to user preferences. From there, the training process includes evaluation and iteration precision and recall. This step facilitates the model accurately recommending controls and minimizing false positives (e.g., unnecessarily restrictive controls). Surveys or usage metrics to gauge if the controls recommended match customer expectations and enhance their experience can also be incorporated and used to further train the ML model. The model can then be integrated into a banking or merchant payment app, providing real-time recommendations when users are setting up virtual card numbers for transactions or providing automated selection of optimized controls.

The training process is described next. Before training can begin, the system preprocesses the data. More specifically, the artificial intelligence system 130 starts by normalizing transaction amounts, and encoding categorical variables (merchant category, transaction type), and handle missing values. Next, the artificial intelligence system 130 splits the data, including dividing the dataset into training, validation, and test sets to evaluate the model's performance. Then, training beings. In model training, the artificial intelligence system 130 uses a training dataset with examples of issuer user transactions and the controls that were (or would have been) optimal. This can involve using historical data where the outcomes of certain control settings are known.

Once the model is trained, then model validation and tuning is performed. The artificial intelligence system 130 uses a validation set to fine-tune hyperparameters and select the model with the best performance based on evaluation metrics. Next, the artificial intelligence system 130 training process includes incorporating feedback and allowing for a mechanism where users, such as the user of user device 108, can provide feedback on the recommendations, which can be used as additional training data to further refine the model. The model is then used by artificial intelligence system 130 to make various predictions and decisions described herein with respect to the creation of the VCNs and controls therefor.

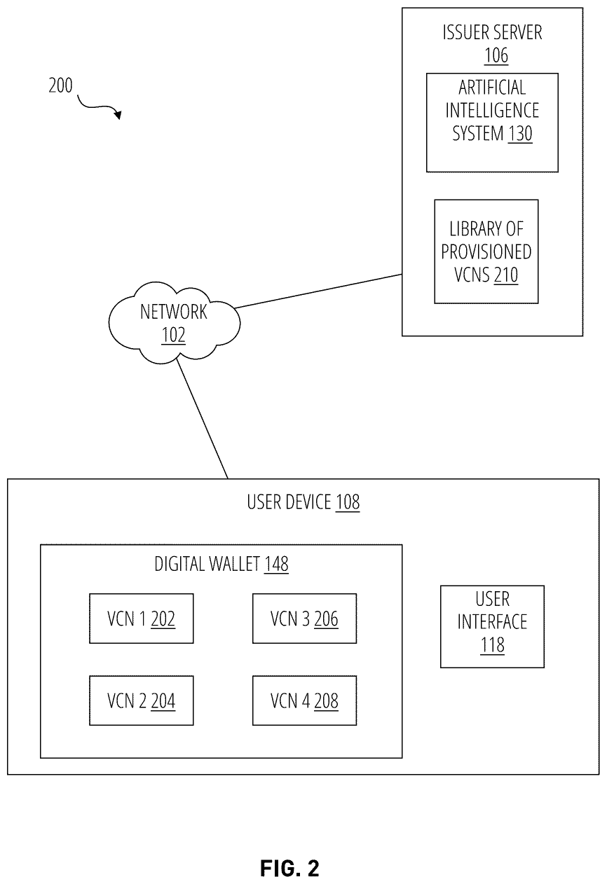

FIG. 2 illustrates an example VCN management network 200 to manage VCNs provisioned in the digital wallet 148 of the user device 108. Although only one user device 108 is shown, the VCN management network 200 can manage the VCNs provisioned for multiple user devices. The artificial intelligence system 130 keeps track of all of the VCNs provisioned. For example, in the embodiment illustrated in FIG. 2, the digital wallet 148 of the user device 108 includes four VCNs provisioned thereon: VCN 1 202, VCN 2 204, VCN 3 206, and VCN 4 208. These VCNs were previously provisioned on the digital wallet 148 by the artificial intelligence system 130. The artificial intelligence system 130 is configured to automatically clean-up, delete, lock, or otherwise manage unused VCNs generated thereby.

In one example embodiment, the artificial intelligence system 130 may send a message to the user device 108 to display on the user interface 118 to prompt the user to determine whether a provisioned VCN should be removed or deleted. For example, the artificial intelligence system 130 may notice that one or more VCN has been provisioned for a certain amount of time without use. In this case, the artificial intelligence system 130 may send a message that causes a prompt to be displayed on the user interface 118 of the user device 108 to ask the user if they would like the one or more VCN to be removed. If the user indicates (via selecting a button on the user interface 118) that they wish to remove one or more of the VCNs, the artificial intelligence system 130 will deprovision the VCN selected. For example, the artificial intelligence system 130 can send a message to the user device 108 that displays a list of VCNs to be removed and the user can select which of the VCNs to remove. In response to the user selecting which VCNs to remove, for example, VCN 1 202 and VCN 2 204, the artificial intelligence system 130 will remove the VCN on the backend (e.g., from its own systems) but also the artificial intelligence system 130 will send a message to the user device 108 to remove VCN 1 202 and VCN 2 204 from the digital wallet 148.

In another example embodiment, in the background, and without prompting, the artificial intelligence system 130 will manage and keep track of the VCNs provisioned on the digital wallet 148. After a certain amount of time with no use, or after a given number of uses (e.g., after one use for a one-time use VCN), the artificial intelligence system 130 will automatically remove the VCN from its own systems and then automatically send a message to the user device 108 to delete the VCN from the digital wallet 148. In some examples, the artificial intelligence system 130 maintains a library of provisioned VCNs 210 and to whom they are provisioned. In this embodiment, the artificial intelligence system 130 can constantly or periodically scan the library of provisioned VCNs 210 and determine which VCNs should be removed based on certain criteria (e.g., time elapsed since the VCN was created or when last used, amount spent using the VCN, number of purchases made with VCN, etc.).

In some embodiments, the artificial intelligence system 130 is trained using previous data indicting when VCNs were previously removed, how long they lasted, and for what reasons they were removed. In some embodiments, the artificial intelligence system 130 can make predictions on when a present VCN should be removed based on the machine learning training on previous removals. In some embodiments, the artificial intelligence system 130 can use these predictions to automatically remove unused VCNs generated by the artificial intelligence system 130.

In some other embodiments, the user of the user device 108 can prompt, via the user interface 118, the artificial intelligence system 130 to remove one or more VCNs. For example, the user knows they will never again use VCN 2 204 and VCN 4 208. As such, the user can indicate on the user interface 118, for example, using the mobile application 122, that the VCN 2 204 and VCN 4 208 should be removed. Once the artificial intelligence system 130 receives the request, the artificial intelligence system 130 can remove the VCN 2 204 and VCN 4 208 from its own systems and send a message to the digital wallet 148 to remove the VCNs. In an alternative embodiment, the user can verbally request, via digital assistant 124 on the user device 108 to remove the VCNs. The same process will be performed by the artificial intelligence system 130 to remove the VCN 2 204 and VCN 4 208.

By removing the VCNs, the artificial intelligence system 130 can dynamically free up memory 116 on the user device 108 and make the device operate more efficiently and quickly. This improves the technology of the VCN creation process because it helps to prevent memory leaks on the user device 108 preventing memory overutilization.

In some embodiments, the artificial intelligence system 130 can either automatically, or via prompt from the user, generate a VCN, such as VCN 1 202 and provision the VCN to the user device 108. Once the VCN is provisioned, the artificial intelligence system 130 can automatically monitor the use of the VCN and determine when a removal setting has been reached. For example, if the VCN 1 202 has been used its allotted number of uses, or its allotted spending amount, or if the VCN 1 202 has not been used in a given amount of time, or any other setting has been reached, the artificial intelligence system 130 can send a signal or message to the user device 108 to automatically remove the VCN 1 202 from the digital wallet 148. Alternatively, the user can prompt the artificial intelligence system 130 to send the signal or message to remove the VCN 1 202. The VCNs discussed above can be associated with the contactless card 110 shown in FIG. 1A. The VCNs can help prevent public use of the PAN of the contactless card 110 and the issuer server 106 will associate purchases made with the VCNs with the contactless card 110 and the user account of the user. Therefore, any purchase made using the VCNs will still be added to the balance of the contactless card 110 by the issuer server 106.

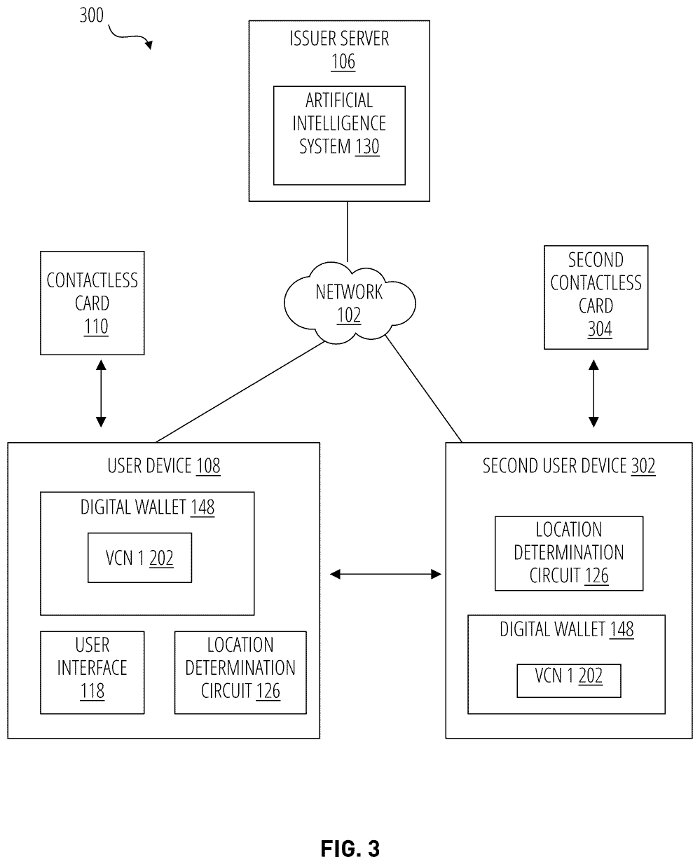

FIG. 3 illustrates an example multi-user network 300 that includes the issuer server 106, including the artificial intelligence system 130, and the user device 108 of previous figures, but also includes a second user device 302 in proximity to the user device 108. The second user device 302 is also connected to the network 102 and can communicate with the issuer server 106 over the network 102. The second user device 302 can comprise any suitable computing device similar to that of user device 108. In the examples described herein, the second user device 302 can be a mobile device such as a smart phone. Like the user device 108 and second user device 302 can include a location determination circuit 126 and a digital wallet 148 to hold and use VCNs.

In some embodiments, the second user device 302 can determine its location using the location determination circuit 126 and share the location data with the data source 104 and the artificial intelligence system 130. As discussed above, the user device 108 also determines its location based on the location determination circuit 126 located thereon and shares that location data with the artificial intelligence system 130 and data source 104. The artificial intelligence system 130 can determine when the second user device 302 is in proximity of the user device 108 in certain instances, and based on an association between the user device 108 and the second user device 302, the artificial intelligence system 130 can provision a VCN associated with the contactless card 110 to the second user device 302 such that purchases made by the second user device 302 using the VCN provisioned thereto will be added to the balance of the contactless card 110 associated with the contactless card 110 and the user of the user device 108.

In this example, the artificial intelligence system 130 can leverage the data source 104, including historical and present data and location data from the user device 108 and second user device 302. In some instances in the past, the user device 108 may have shared a VCN with the second user device 302 when the user device 108 was in proximity of the second user device 302. For example, the second user device 302 is a mobile device of a child and user device 108 is the mobile device of the parent of that child. Every time the parent and child are located at, e.g., a mall, the user device 108 requests provision of a VCN to the second user device 302 so the child can use the VCN for payment at merchants at the mall. The artificial intelligence system 130 can further leverage transaction history data from the issuer server 106 to provision the VCN. For example, when a VCN is created for a family member or other person associated with the user of user device 108, the artificial intelligence system 130 can consider the transaction history data and provision the VCN based on the prior transactions. In one example, the transaction history data indicates that the user spends $100 at Merchant X. The artificial intelligence system 130 may provision the VCN to send to the second user device 302 with a limit of $100 at Merchant X and provide those limits based on the review of the transaction history from the issuer server 106.

The artificial intelligence system 130 will learn this by looking at the historical data in the data source 104. In some embodiments, the artificial intelligence system 130 will determine that both of the user device 108 and the second user device 302 are located at the mall or some other location (based on previous history), and if the user device 108 and second user device 302 are in proximity to each other, the artificial intelligence system 130 can provision a VCN to the second user device 302 on behalf of the user device 108. In some cases, the artificial intelligence system 130 will perform this automatically based on predictions made from the historical data. In other cases, like the methods described above, the artificial intelligence system 130 will prompt the user of the user device 108 if they want to provision a VCN on the second user device 302 or the user will request the VCN provision on their own. In an example, the artificial intelligence system 130 can be trained using the historical data associated with user device 108 and predict that, like in past cases, when at the mall, the user device 108 will provision a VCN to the second user device 302 (e.g., the child's phone) with a spend limit of $100 set to the VCN in the digital wallet 148.

As described herein, the artificial intelligence system 130 can provision the VCN sent to the digital wallet 148 of the second user device 302 with specific controls. For example, the VCN may be limited to certain merchants, limited to a specific location, or may have spending limits set. These controls can also be learned based on historical data or these controls can be a part of settings established in the mobile application 122. That is, the parent can set in the mobile application 122 where the VCN provisioned to the second user device 302 can be used (merchant, geographic location) and the spending limit. There can also be device specific settings.

In another example embodiment, instead of causing a VCN to be provisioned on the second user device 302, the user device 108 is to pay the second user for a good or service using their user device 108. In this example, the user of the user device 108 needs to pay the second user of the second user device 302 for goods or services. In this case, the second user of the second user device 302 may or may not be related to the user device 108. In this example, the user of the user device 108 will pay the user of the second user device 302 by tapping the user device 108 to the second user device 302 and an NFC exchange will happen.

Presently, peer to peer (P2P) payments via NFCs are only performed between devices of the same operating system. For example, only Android devices can exchange payment via NFC with other Android users and similar for iphone users. However, in this case, the artificial intelligence system 130 or some other AI system (e.g., not associated with the issuer server 106, but instead a neutral third party server) will detect the NFC tag sent from the user device 108 to the second user device 302 and recognize the NFC tag/token of the user device 108 and complete the payment. The second user device 302 can receive the NFC token and transmit it to the artificial intelligence system 130 and the artificial intelligence system 130 can analyze the NFC token/tag and cause the payment to be sent from the user device 108 to the second user device 302. As an example, the user device 108 is an Android device and the second user device 302 is an iPhone device. The P2P payment can occur as described above using the artificial intelligence system 130 or some other AI system.

In another embodiment, one or both of the user device 108 and the second user device 302 are to prove their identity to the other before any VCN is provisioned to the second user device 302. For example, the user of user device 108 can tap their contactless card 110 to the user device 108 and perform an NFC exchange therebetween. In this case, encrypted data is passed from the contactless card 110 to the user device 108 that verifies an identity of the user of the contactless card 110. The encrypted data can be sent to the issuer server 106 or other server that verifies the identity of the user by decrypting the encrypted data. If the decrypted data matches expected data for the user, then the user's identity is verified. The same process can be done with the second contactless card 304 being tapped to the second user device 302 and second encrypted data passed thereto. The second encrypted data can then be sent to issuer server 106 or another authentication server to decrypt the second encrypted data and compare it to expected second decrypted data. If the second decrypted data matches the second expected decrypted data, then the second user associated with the second user device 302 is verified. Once this verification step happens, the P2P payment and exchange can occur. Such a requirement may be present in some embodiments, and not required in others.

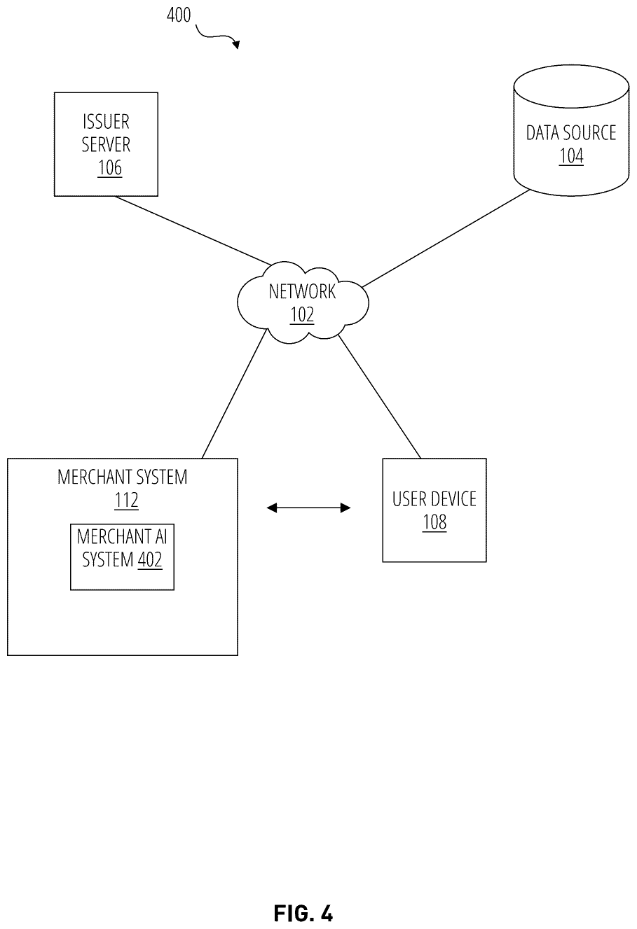

FIG. 4 illustrates a network diagram for a feature provisioning system 400. In some cases, the feature to be provisioned can include a merchant generated gift card or discount applied to a VCN, NFC token, or Gift card already provisioned on the user device 108. For example, if the digital wallet 148 includes a gift card or VCN already associated with a particular merchant, the gift card or VCN can be updated to include a discount or gift card balance.

In some cases, the merchant may use a merchant AI system 402 itself and, based on historical data from the data source 104 and based on the location data from the user device 108, the merchant AI can detect that a user and its user device 108 has entered the merchant's location. The merchant AI system 402 can then send the digital wallet 148 of the user device 108 a VCN in the form of a gift card or discount code for the merchant, the VCN including money that the user can use at the merchant's store.

In this example embodiment, the merchant AI system 402 will use geolocation data and NFC tags of the user device 108 to detect if a customer is within the appropriate proximity of the merchant's store. In response to the merchant AI system 402 detecting that the user and the user device 108 is within the appropriate proximity to the store, the merchant AI system 402 can send a signal to the issuer server 106 to provision a VCN to the user device 108. The VCN pushed by the issuer server 106 can have similar controls discussed above, including location controls (e.g., can only use the VCN at the merchant's store) and can have time limits (only on certain days), as well as spending limits. In some embodiments, the user can be prompted on the user interface 118 of the user device 108 to approve or authorize the transfer of the VCN onto their user device 108 before it is added to the digital wallet 148.

In one example, a store is running a marketing campaign, giving users $15 off store-wide. The user, with their user device 108, walks into the store and the merchant AI system 402 detects that the user has entered the store. For example, the merchant AI system 402 may determine that the user device 108 and user have entered the store by receiving the location data of the user device 108 (e.g., by receiving a message from the user device 108). In another embodiment, the user device 108 can have an application downloaded thereon associated with the merchant, and the user can share their location with the application, which then shares the location information with the 402. The merchant AI system 402 then determines that the user has entered the merchant's location based on the location data shared over the application. The merchant AI system 402 may also determine the presence of the user based on social media posts by the user (e.g., “checking in” on a social media post on the user device 108). In response to the detection, the merchant AI system 402 sends a signal to the issuer server 106 to provision a VCN with a $15 discount to the user device 108. In some cases, the issuer server 106 does not need to send the VCN. It can instead be provisioned by the merchant AI system 402 of the merchant system 112. In this example, the user has an account with the merchant system 112, which then sends the VCN to the user device 108 through the account. The user is prompted on the user interface 118 to accept or deny the VCN provisioned and if they accept, the VCN is provisioned to their digital wallet 148.

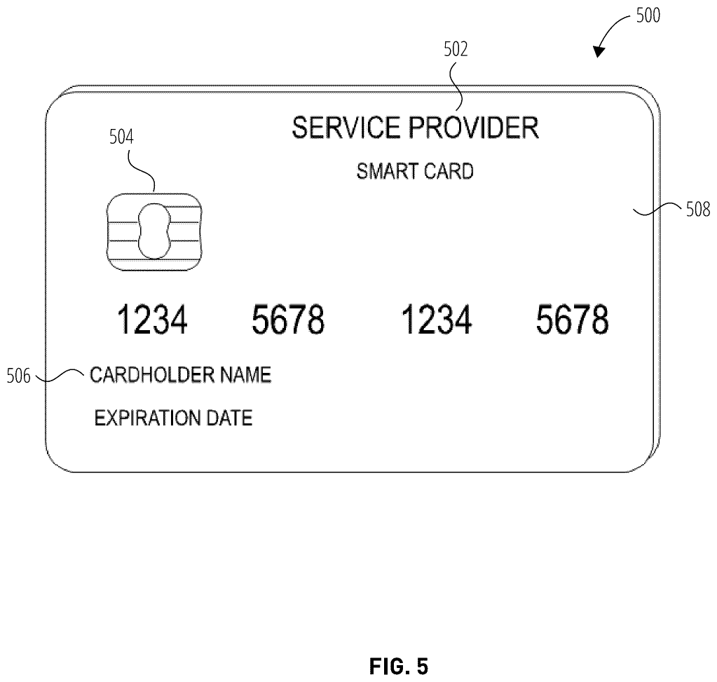

FIG. 5 illustrates an example configuration of contactless card 500, which may include a contactless card, a payment card, such as a credit card, debit card, or gift card, issued by a service provider as displayed as service provider indicia 502 on the front or back of the contactless card 500. In some examples, the contactless card 500 is not related to a payment card, and may include, without limitation, an identification card. In some examples, the transaction card may include a dual interface contactless payment card, a rewards card, and so forth. The contactless card 500 may include a substrate 508, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 100 may have physical characteristics compliant with the ID-1 format of the ISO/IEC 7816 standard, and the transaction card may otherwise be compliant with the ISO/IEC 14443 standard. However, it is understood that the contactless card 500, according to the present disclosure, may have different characteristics, and the present disclosure does not require a transaction card to be implemented in a payment card.

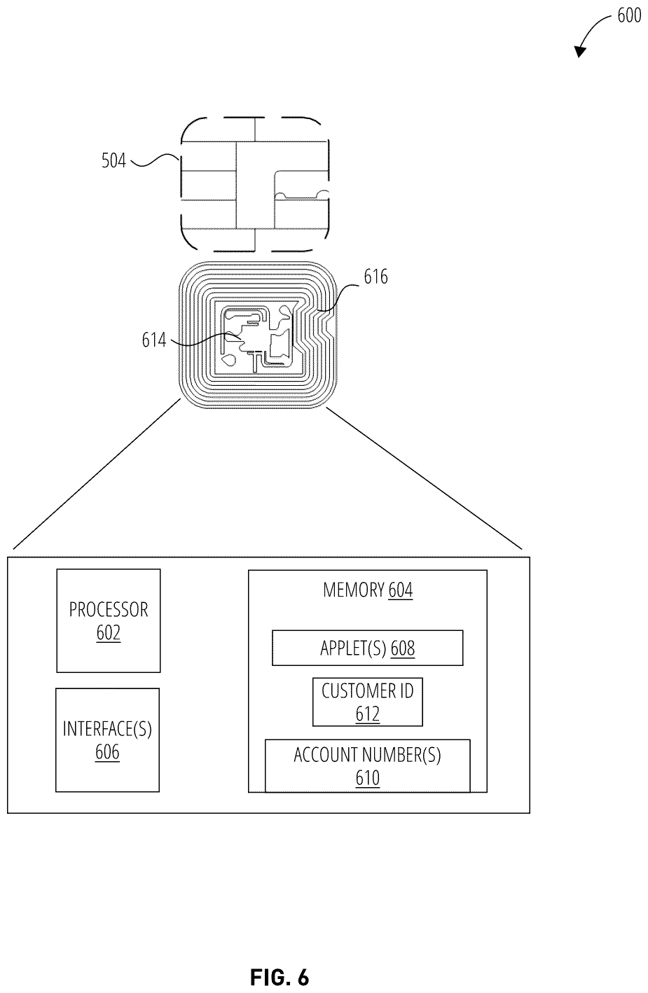

The contactless card 500 may also include identification information 506 displayed on the card's front and/or back, and a contact pad 504. The contact pad 504 may include one or more pads and be configured to establish contact with another client device, such as an automated teller machine (ATM), a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 500 may also include processing circuitry, antenna and other components as will be further discussed in FIG. 6. These components may be located behind the contact pad 504 or elsewhere on the substrate 508, e.g. within a different layer of the substrate 508, and may electrically and physically coupled with the contact pad 504. The contactless card 500 may also include a magnetic strip or tape, which may be located on the back of the card (not shown in FIG. 5). The contactless card 500 may also include a Near-Field Communication (NFC) device coupled with an antenna capable of communicating via the NFC protocol. Embodiments are not limited in this manner.

As illustrated in FIG. 6, the contact pad 504 of contactless card 500 may include processing circuitry 614 for storing, processing, and communicating information, including a processor 602, a memory 604, and one or more interface(s) 606. It is understood that the processing circuitry 614 may contain additional components, including processors, memories, error, and parity/CRC checkers, data encoders, anticollision algorithms, controllers, command decoders, security primitives, and tamper-proofing hardware, as necessary to perform the functions described herein.

The memory 604 may be a read-only memory, write-once read-multiple memory or read/write memory, e.g., RAM, ROM, and EEPROM, and the contactless card 100 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programmed many times after leaving the factory. A read/write memory may also be read many times after leaving the factory. In some instances, the memory 604 may be encrypted using an encryption algorithm executed by the processor 602 to encrypt data.

The memory 604 may be configured to store one or more applet(s) 608, a customer identifier 612, and the account number(s) 610, which may be virtual account numbers. The one or more applet(s) 608 may include one or more software applications configured to execute on one or more contactless cards, such as a Java® Card applet. However, it is understood that applet(s) 608 are not limited to Java Card applets, and instead may be any software application operable on contactless cards or other devices having limited memory. The customer identifier 612 may comprise a unique alphanumeric identifier assigned to a user of the contactless card 100, and the identifier may distinguish the user of the contactless card from other contactless card users. In some examples, the customer identifier 612 may identify both a customer and an account assigned to that customer and may further identify the contactless card 100 associated with the customer's account. As stated, the account number(s) 610 may include thousands of one-time use virtual account numbers associated with the contactless card 100. An applet(s) 608 of the contactless card 100 may be configured to manage the account number(s) 610 (e.g., to select an account number(s) 610, mark the selected account number(s) 610 as used, and transmit the account number(s) 610 to a mobile device for auto-filling by an auto-filling service.

The processor 602 and memory elements of the foregoing exemplary embodiments are described with reference to the contact pad 504, but the present disclosure is not limited thereto. It is understood that these elements may be implemented outside of the contact pad 504 or entirely separate from it or as further elements in addition to processor 602 and memory 604 elements located within the contact pad 504.

In some examples, the contactless card 500 may comprise one or more antenna(s) 616. The one or more antenna(s) 616 may be placed within the contactless card 100 and around the processing circuitry 614 of the contact pad 504. For example, the one or more antenna(s) 616 may be integral with the processing circuitry 614 and the one or more antenna(s) 616 may be used with an external booster coil. As another example, the one or more antenna(s) 616 may be external to the contact pad 504 and the processing circuitry 614.

In an embodiment, the coil of contactless card 500 may act as the secondary of an air core transformer. The terminal may communicate with the contactless card 500 by cutting power or amplitude modulation. The contactless card 500 may infer the data transmitted from the terminal using the gaps in the contactless card's power connection, which may be functionally maintained through one or more capacitors. The contactless card 500 may communicate back by switching a load on the contactless card's coil or load modulation. Load modulation may be detected in the terminal's coil through interference. More generally, using the antenna(s) 616, processor 602, and/or the memory 604, the contactless card 500 provides a communications interface to communicate via NFC, Bluetooth, and/or Wi-Fi communications.

The contactless card 500 may be built on a software platform operable on smart cards or other devices with limited memory, such as JavaCard. One or more applications or applets may be securely executed. Applet(s) 608 may be added to the contactless card 500 to provide a one-time password (OTP) for multifactor authentication (MFA) in various mobile application-based use cases. The OTP may include the encrypted data discussed herein. Applet(s) 608 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag. In embodiments, one or more applet(s) 608 may be installed at the time of manufacturing, personalization, and/or after the user has possession of the contactless card 500.

One example of an NDEF OTP is an NDEF short-record layout (SR=1). In such an example, one or more applet(s) 608 may be configured to encode the OTP as an NDEF type 4 well known type text tag. In some examples, NDEF messages may comprise one or more records. The applet(s) 608 may be configured to add one or more static tag records in addition to the OTP record.

In some examples, the one or more applet(s) 608 may be configured to emulate an RFID tag. The RFID tag may include one or more polymorphic tags. In some examples, each time the tag is read, different cryptographic data is presented that may indicate the authenticity of the contactless card. Based on the one or more applet(s) 608, an NFC read of the tag may be processed, the data may be transmitted to a server, such as a server of a banking system, and the data may be validated at the server.

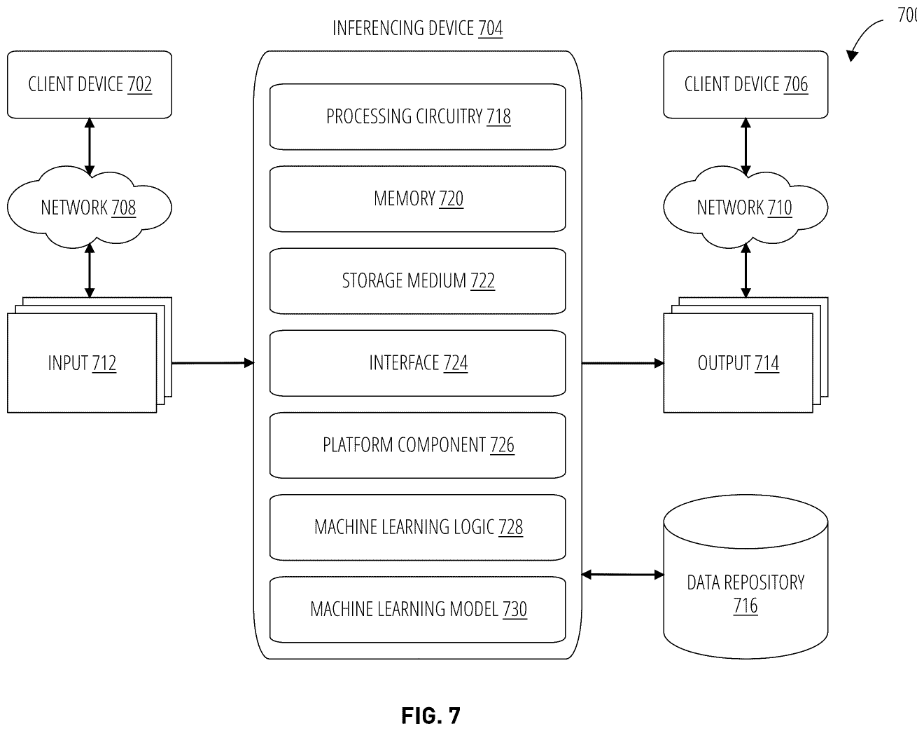

FIG. 7 illustrates an embodiment of a system 700. The system 700 is suitable for implementing one or more embodiments as described herein. In one embodiment, for example, the system 700 is an AI/ML system suitable for providing the artificial intelligence system 130 described above. Therefore, the system 700 is representative of the components of the VCN generation system 100.

The system 700 comprises a set of M devices, where M is any positive integer. FIG. 7 depicts three devices (M=3), including a client device 702, an inferencing device 704, and a client device 706. The inferencing device 704 communicates information with the client device 702 and the client device 706 over a network 708 and a network 710, respectively. The information may include input 712 from the client device 702 and output 714 to the client device 706, or vice-versa. In one alternative, the input 712 and the output 714 are communicated between the same client device 702 or client device 706. In another alternative, the input 712 and the output 714 are stored in a data repository 716. In yet another alternative, the input 712 and the output 714 are communicated via a platform component 726 of the inferencing device 704, such as an input/output (I/O) device (e.g., a touchscreen, a microphone, a speaker, etc.). The client devices 102 are representative of the client device 702, client device 702, or the inferencing device 704.

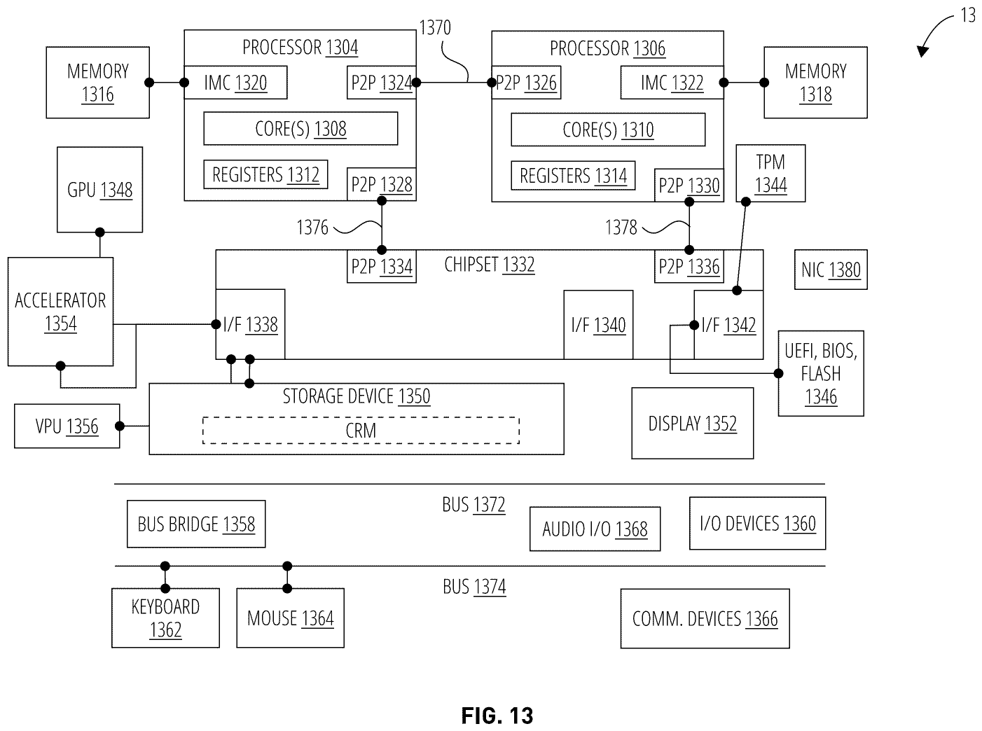

As depicted in FIG. 7, the inferencing device 704 includes processing circuitry 718, a memory 720, a storage medium 722, an interface 724, a platform component 726, ML logic 728, and an ML model 730. In some implementations, the inferencing device 704 includes other components or devices as well. Examples for software elements and hardware elements of the inferencing device 704 are described in more detail with reference to a computing architecture 1300 as depicted in FIG. 13. Embodiments are not limited to these examples.

The inferencing device 704 is generally arranged to receive an input 712, process the input 712 via one or more AI/ML techniques, and send an output 714. The inferencing device 704 receives the input 712 from the client device 702 via the network 708, the client device 706 via the network 710, the platform component 726 (e.g., a touchscreen as a text command or microphone as a voice command), the memory 720, the storage medium 722 or the data repository 716. The inferencing device 704 sends the output 714 to the client device 702 via the network 708, the client device 706 via the network 710, the platform component 726 (e.g., a touchscreen to present text, graphic or video information or speaker to reproduce audio information), the memory 720, the storage medium 722 or the data repository 716. Embodiments are not limited to these examples.

The inferencing device 704 includes ML logic 728 and an ML model 730 to implement various AI/ML techniques for various AI/ML tasks. The ML logic 728 receives the input 712, and processes the input 712 using the ML model 730. The ML model 730 performs inferencing operations to generate an inference for a specific task from the input 712. In some cases, the inference is part of the output 714. The output 714 is used by the client device 702, the inferencing device 704, or the client device 706 to perform subsequent actions in response to the output 714.

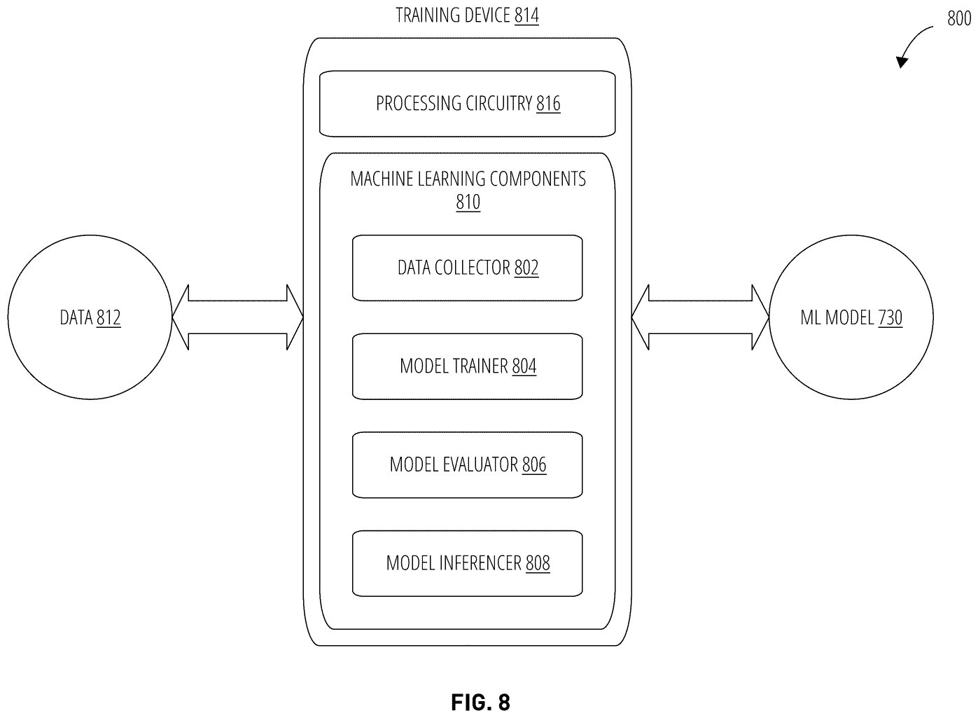

In various embodiments, the ML model 730 is a trained ML model 730 using a set of training operations. The ML model 730 is representative of the artificial intelligence system 130. An example of training operations to train the ML model 730, including the artificial intelligence system 130, is described with reference to FIG. 8.

FIG. 8 illustrates an apparatus 800. The apparatus 800 depicts a training device 814 suitable to generate a trained ML model 730 for the inferencing device 704 of the system 700. As depicted in FIG. 8, the training device 814 includes a processing circuitry 816 and a set of ML components 810 to support various AI/ML techniques, such as a data collector 802, a model trainer 804, a model evaluator 806 and a model inferencer 808. As stated, the ML model 730 is representative of the artificial intelligence system 130.

In general, the data collector 802 collects data 812 from one or more data sources to use as training data for the ML model 730. The data collector 802 collects different types of data 812, such as text information, audio information, image information, video information, graphic information, and so forth. The data stored by the data source 104, merchant system 112, and issuer server 106 are examples of data 812 used to train the artificial intelligence system 130 as ML models 730. The model trainer 804 receives as input the collected data and uses a portion of the collected data as test data for an AI/ML algorithm to train the ML model 730. The model evaluator 806 evaluates and improves the trained ML model 730 using a portion of the collected data as test data to test the ML model 730. The model evaluator 806 also uses feedback information from the deployed ML model 730. The model inferencer 808 implements the trained ML model 730 to receive as input new unseen data, generate one or more inferences on the new data, and output a result such as an alert, a recommendation or other post-solution activity.

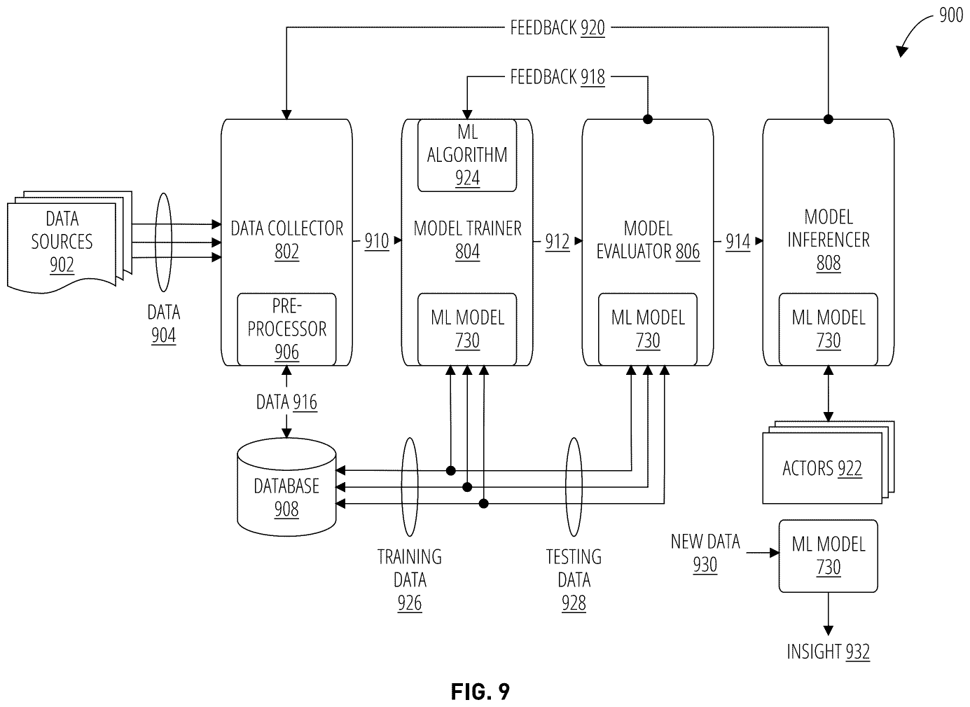

An exemplary AI/ML architecture for the ML components 810 is described in more detail with reference to FIG. 9.

FIG. 9 illustrates an artificial intelligence architecture 900 suitable for use by the training device 814 to generate the ML model 730 for deployment by the inferencing device 704. As stated, the artificial intelligence system 130 are examples of the ML model 730. Therefore, artificial intelligence architecture 900 is representative of an embodiment to train and generate the artificial intelligence system 130. The artificial intelligence architecture 900 is an example of a system suitable for implementing various AI techniques and/or ML techniques to perform various inferencing tasks on behalf of the various devices of the system 700.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 900 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 730, evaluate performance of the trained ML model 730, and deploy the tested ML model 730 as the trained ML model 730 in a production environment, and continuously monitor and maintain it.

The ML model 730 is a mathematical construct used to predict outcomes based on a set of input data. The ML model 730 is trained using large volumes of training data 926, and it can recognize patterns and trends in the training data 926 to make accurate predictions. The ML model 730 is derived from an ML algorithm 924 (e.g., a neural network, decision tree, support vector machine, etc.). A data set is fed into the ML algorithm 924 which trains an ML model 730 to “learn” a function that produces mappings between a set of inputs and a set of outputs with a reasonably high accuracy. Given a sufficiently large enough set of inputs and outputs, the ML algorithm 924 finds the function for a given task. This function may even be able to produce the correct output for input that it has not seen during training. A data scientist prepares the mappings, selects and tunes the ML algorithm 924, and evaluates the resulting model performance. Once the ML logic 728 is sufficiently accurate on test data, it can be deployed for production use.

The ML algorithm 924 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 924 of the artificial intelligence architecture 900 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 9, the artificial intelligence architecture 900 includes a set of data sources 902 to source data 904 for the artificial intelligence architecture 900. Data sources 902 may comprise any device capable generating, processing, storing or managing data 904 suitable for a ML system. Examples of data sources 902 include without limitation the data source 104 merchant system 112, issuer server 106, databases, web scraping, sensors and Internet of Things (IoT) devices, image and video cameras, audio devices, text generators, publicly available databases, private databases, and many other data sources 902. The data sources 902 may be remote from the artificial intelligence architecture 900 and accessed via a network, local to the artificial intelligence architecture 900 an accessed via a network interface, or may be a combination of local and remote data sources 902. In some embodiments, the data source 104, merchant system 112, and/or issuer server 106 are representative of the data sources 902, and the data stored by the data source 104, merchant system 112, and issuer server 106 are representative of the data 904 to train the artificial intelligence system 130 as ML models 730.

The data sources 902 source difference types of data 904. By way of example and not limitation, the data 904 includes structured data from relational databases, such as customer profiles, transaction histories, or product inventories. The data 904 also includes the data discussed with respect to FIG. 1C above. The data 904 includes unstructured data from websites such as the websites themselves, customer reviews, news articles, social media posts, or product specifications. The data 904 includes data from temperature sensors, motion detectors, and smart home appliances. The data 904 includes image data from medical images, security footage, or satellite images. The data 904 includes audio data from speech recognition, music recognition, or call centers. The data 904 includes text data from emails, chat logs, customer feedback, news articles or social media posts. The data 904 includes publicly available datasets such as those from government agencies, academic institutions, or research organizations. These are just a few examples of the many sources of data that can be used for ML systems. It is important to note that the quality and quantity of the data is critical for the success of a machine learning project.

The data 904 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 902 are communicatively coupled to a data collector 802. The data collector 802 gathers relevant data 904 from the data sources 902. Once collected, the data collector 802 may use a pre-processor 906 to make the data 904 suitable for analysis. This involves data cleaning, transformation, and feature engineering. Data preprocessing is a critical step in ML as it directly impacts the accuracy and effectiveness of the ML model 730. The pre-processor 906 receives the data 904 as input, processes the data 904, and outputs pre-processed data 916 for storage in a database 908. Examples for the database 908 includes a hard drive, solid state storage, and/or random access memory (RAM).

The data collector 802 is communicatively coupled to a model trainer 804. The model trainer 804 performs AI/ML model training, validation, and testing which may generate model performance metrics as part of the model testing procedure. The model trainer 804 receives the pre-processed data 916 as input 910 or via the database 908. The model trainer 804 implements a suitable ML algorithm 924 to train an ML model 730 on a set of training data 926 from the pre-processed data 916. The training process involves feeding the pre-processed data 916 into the ML algorithm 924 to produce or optimize an ML model 730 such as the artificial intelligence system 130. The training process adjusts its parameters until it achieves an initial level of satisfactory performance.

The model trainer 804 is communicatively coupled to a model evaluator 806. After an ML model 730 is trained, the ML model 730 needs to be evaluated to assess its performance. This is done using various metrics such as accuracy, precision, recall, and F1 score. The model trainer 804 outputs the ML model 730, which is received as input 910 or from the database 908. The model evaluator 806 receives the ML model 730 as input 912, and it initiates an evaluation process to measure performance of the ML model 730. The evaluation process includes providing feedback 918 to the model trainer 804. The model trainer 804 re-trains the ML model 730 to improve performance in an iterative manner.

The model evaluator 806 is communicatively coupled to a model inferencer 808. The model inferencer 808 provides AI/ML model inference output (e.g., inferences, predictions or decisions). Once the ML model 730 is trained and evaluated, it is deployed in a production environment where it is used to make predictions on new data. The model inferencer 808 receives the evaluated ML model 730 as input 914. The model inferencer 808 uses the evaluated ML model 730 to produce insights or predictions on real data, which is deployed as a final production ML model 730. The inference output of the ML model 730 is use case specific. The model inferencer 808 also performs model monitoring and maintenance, which involves continuously monitoring performance of the ML model 730 in the production environment and making any necessary updates or modifications to maintain its accuracy and effectiveness. The model inferencer 808 provides feedback 918 to the data collector 802 to train or re-train the ML model 730. The feedback 918 includes model performance feedback information, which is used for monitoring and improving performance of the ML model 730.

Some or all of the model inferencer 808 is implemented by various actors 922 in the artificial intelligence architecture 900, including the ML model 730 of the inferencing device 704, for example. The actors 922 use the deployed ML model 730 on new data to make inferences or predictions for a given task, and output an insight 932. The actors 922 implement the model inferencer 808 locally, or remotely receives outputs from the model inferencer 808 in a distributed computing manner. The actors 922 trigger actions directed to other entities or to itself. The actors 922 provide feedback 920 to the data collector 802 via the model inferencer 808. The feedback 920 comprise data needed to derive training data, inference data or to monitor the performance of the ML model 730 and its impact to the network through updating of key performance indicators (KPIs) and performance counters.

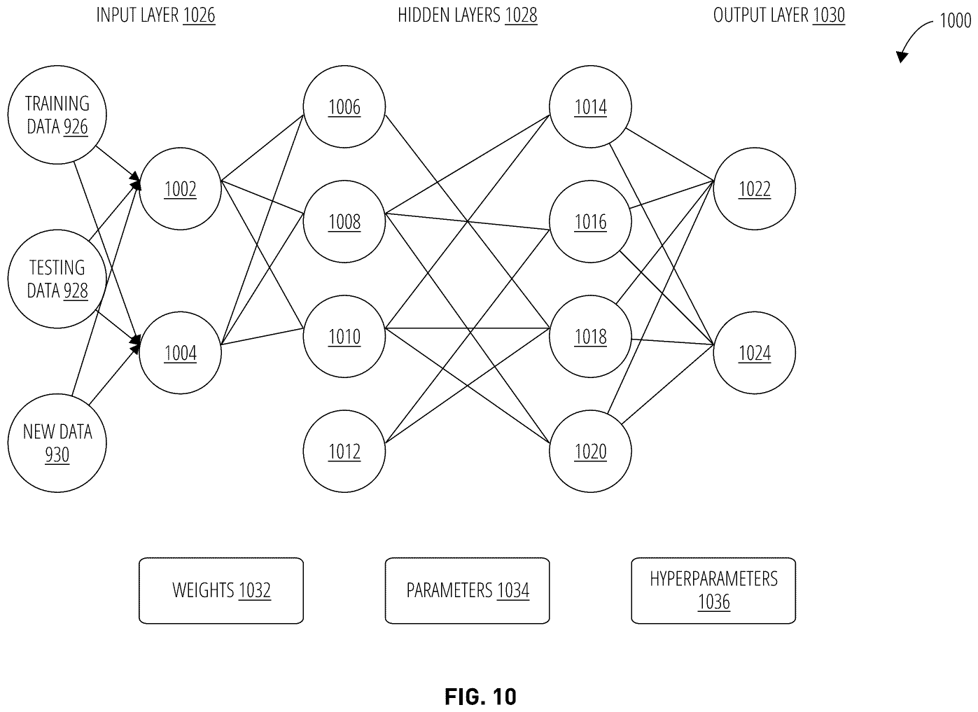

As previously described with reference to FIGS. 7 and 8, the systems 700 and 800 implement some or all of the artificial intelligence architecture 900 to support various use cases and solutions for various AI/ML tasks. In various embodiments, the training device 814 of the apparatus 800 uses the artificial intelligence architecture 900 to generate and train the ML model 730 for use by the inferencing device 704 for the system 700. In various embodiments, the training device 814 uses the artificial intelligence architecture 900 to generate and train the artificial intelligence system 130 for use by the issuer server 106 and/or the merchant system 112 of FIG. 1A. In one embodiment, for example, the training device 814 may train the ML model 730 (e.g., the artificial intelligence system 130) as a neural network, as described in more detail with reference to FIG. 10. Other use cases and solutions for AI/ML are possible as well, and embodiments are not limited in this context.

FIG. 10 illustrates an embodiment of an artificial neural network 1000. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another. The artificial neural network 1000 is representative of the artificial intelligence system 130.

Artificial neural network 1000 comprises multiple node layers, containing an input layer 1026, one or more hidden layers 1028, and an output layer 1030. Each layer comprises one or more nodes, such as nodes 1002 to 1024. As depicted in FIG. 10, for example, the input layer 1026 has nodes 1002, 1004. The artificial neural network 1000 has two hidden layers 1028, with a first hidden layer having nodes 1006, 1008, 1010 and 1012, and a second hidden layer having nodes 1014, 1016, 1018 and 1020. The artificial neural network 1000 has an output layer 1030 with nodes 1022, 1024. Each node 1002 to 1024 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1000 relies on training data 926 (which may include data stored by the data source 104, merchant system 112, and/or issuer server 106) to learn and improve accuracy over time. However, once the artificial neural network 1000 is fine-tuned for accuracy, and tested on testing data 928, the artificial neural network 1000 is ready to classify and cluster new data 930 at a high velocity. Tasks in speech recognition or image recognition can take minutes versus hours when compared to the manual identification by human experts.

Each individual node 1002 to 1024 is a linear regression model, composed of input data, weights, a bias (or threshold), and an output. The linear regression model may have a formula similar to Equation (1), as follows:

$$\sum wixi + bias = w 1 x 1 + w 2 x 2 + w 3 x 3 + bias \qquad EQUATION ( 1 )$$

$$output = f ( x ) = 1 if \sum w 1 x 1 + b >= 0 ; 0 if \sum w 1 x 1 + b < 0$$

Once an input layer 1026 is determined, a set of weights 1032 are assigned. The weights 1032 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1000 as a feedforward network.

In one embodiment, the artificial neural network 1000 leverages sigmoid neurons, which are distinguished by having values between 0 and 1. Since the artificial neural network 1000 behaves similarly to a decision tree, cascading data from one node to another, having x values between 0 and 1 will reduce the impact of any given change of a single variable on the output of any given node, and subsequently, the output of the artificial neural network 1000.

The artificial neural network 1000 has many practical use cases, like image recognition, speech recognition, text recognition or classification. The artificial neural network 1000 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = MSE = \frac{1}{2 m} {\sum }_{i = 1}^{n} {( {\hat{y}}_{i} - {y}_{i} )}^{2} \to MIN \qquad EQUATION ( 2 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1034 of the model adjust to gradually converge at the minimum.

In one embodiment, the artificial neural network 1000 is feedforward, meaning it flows in one direction only, from input to output. In one embodiment, the artificial neural network 1000 uses backpropagation. Backpropagation is when the artificial neural network 1000 moves in the opposite direction from output to input. Backpropagation allows calculation and attribution of errors associated with each neuron 1002 to 1024, thereby allowing adjustment to fit the parameters 1034 of the ML model 730 appropriately.

The artificial neural network 1000 is implemented as different neural networks depending on a given task. Neural networks are classified into different types, which are used for different purposes. In one embodiment, the artificial neural network 1000 is implemented as a feedforward neural network, or multi-layer perceptrons (MLPs), comprised of an input layer 1026, hidden layers 1028, and an output layer 1030. While these neural networks are also commonly referred to as MLPs, they are actually comprised of sigmoid neurons, not perceptrons, as most real-world problems are nonlinear. Trained data 904 usually is fed into these models to train them, and they are the foundation for computer vision, natural language processing, and other neural networks. In one embodiment, the artificial neural network 1000 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1000 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1000 is implemented as any type of neural network suitable for a given operational task of systems 700, 800, and the MLP, CNN, and RNN are merely a few examples. Embodiments are not limited in this context.

The artificial neural network 1000 includes a set of associated parameters 1034. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1000 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1036. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

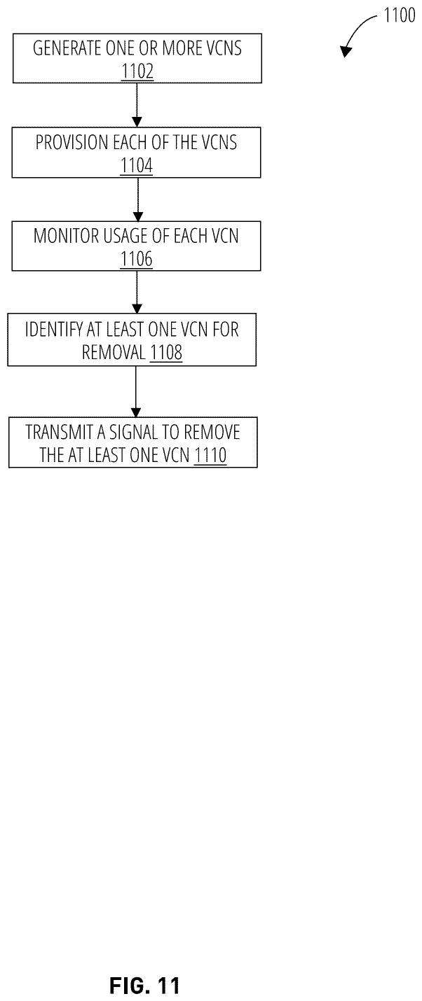

FIG. 11 illustrates a method for VCN management in accordance with one embodiment. The method 1100 begins in step 1102 where the artificial intelligence system 130 in data communication with processor circuit 128 may generate one or more VCNs. For example, the processor circuit 128 may be contained within the issuer server 106 that also stores the artificial intelligence system 130. As another example, the processor circuit 128 may be contained within the issuer server 106 and the artificial intelligence system 130 may be stored externally to the issuer server 106.

In an embodiment, the artificial intelligence system 130 may generate the one or more VCNs responsive to a user prompt received by at least one of the one or more user devices. In another embodiment, the artificial intelligence system 130 may automatically generate the one or more VCNs.

In step 1104, the artificial intelligence system 130 may provision the one or more VCNs to one or more user devices, such as user device 108 and second user device 302. The one or more user devices may store the provisioned VCNs in digital wallets, for example, digital wallet 148.

In step 1106, where the artificial intelligence system 130 may monitor the usage of the provisioned VCNs. In embodiments, the artificial intelligence system 130 may monitor the usage of the VCNs by maintaining and scanning a library of VCNs and their provisioning. The artificial intelligence system 130 may can the library of VCNs on a periodic and/or continuous basis.

In step 1108, the artificial intelligence system 130 may identify at least one of the provisioned VCNs for removal. In an embodiment, the identification of at least one of the one or more VCNs for removal is based upon whether the at least one of the one or more VCNs meetings a removal setting. A removal setting can include, without limitation, an allotted number of uses, an allotted spending limit, a predetermined amount of time with no use, a predetermined amount of time since the creation of the at least one of the one or more VCNs.

In an embodiment, the identification of at least one of the one or more VCNs for removal is based upon a prediction generated by the artificial intelligence system 130. For example, the artificial intelligence system 130 may be trained based on data comprising previous removals of VCNs. The data may further include reasons for the previously removals of VCNs. In an embodiment, the artificial intelligence system 130 may automatically identify at least one of the one or more VCNs for removal based on the prediction.

In an embodiment, the identification of at least one of the one or more VCNs for removal is based upon a user prompt received by at least one of the one or more user devices.

In step 1110, responsive to the identification, the artificial intelligence system 130 may transmit a signal to remove the at least one of the one or more VCNs to at least one of the one or more user devices. In response to this signal, the one or more user devices may remove identified VCNs from digital wallet storage.

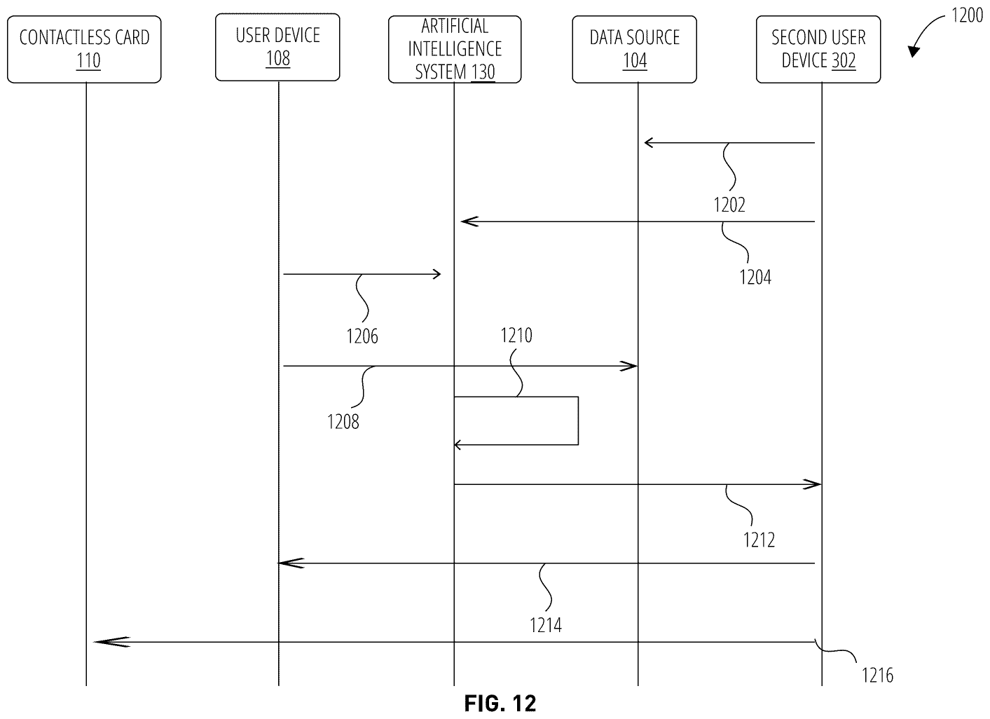

FIG. 12 illustrates a sequence diagram of an operation for VCN management in accordance with one embodiment. The operation 1200 begins in step 1202, where the second user device 302 may determine its location using its location determination circuit 126 and may transmit its location data to the data source 104. The operation further includes step 1204, where second user device 302 may transmit its location data to the artificial intelligence system 130.

In step 1206, the user device 108 may determine its location using its location determination circuit 126 and transmit its location data to the artificial intelligence system 130. In step 1208, the user device 108 may transmit its location data to the data source 104.

In step 1210, the artificial intelligence system 130 may determine that the second user device 302 is in proximity to the user device 108. In an embodiment, based on an association between the second user device 302 and the user device 108, the artificial intelligence system 130 can provision a VCN associated with the contactless card 110 to the second user device. In step 1212, the artificial intelligence system 130 can transmit the provisioned VCN to the second user device 302. In step 1214, a purchase made by the second user device 302 may be associated with the user device 108, and in step 1216, the purchase may be associated with the contactless card 110.

FIG. 13 illustrates an embodiment of a computing architecture 1300. Computing architecture 1300 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1300 has a single processor with one core or more than one processor. Note that the term “processor” refers to a processor with a single core or a processor package with multiple processor cores. In at least one embodiment, the computing architecture 1300 is representative of the components of the system 700. More generally, the computing architecture 1300 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1300. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 13, computing architecture 1300 comprises a system-on-chip (SoC) 1302 for mounting platform components. System-on-chip (SoC) 1302 is a point-to-point (P2P) interconnect platform that includes a first processor 1304 and a second processor 1306 coupled via a point-to-point interconnect 1370 such as an Ultra Path Interconnect (UPI). In other embodiments, the computing architecture 1300 is another bus architecture, such as a multi-drop bus. Furthermore, each of processor 1304 and processor 1306 are processor packages with multiple processor cores including core(s) 1308 and core(s) 1310, respectively. While the computing architecture 1300 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1304 and chipset 1332. Some platforms include additional components and some platforms include sockets to mount the processors and/or the chipset. Furthermore, some platforms do not have sockets (e.g. SoC, or the like). Although depicted as a SoC 1302, one or more of the components of the SoC 1302 are included in a single die package, a multi-chip module (MCM), a multi-die package, a chiplet, a bridge, and/or an interposer. Therefore, embodiments are not limited to a SoC.

The processor 1304 and processor 1306 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1304 and/or processor 1306. Additionally, the processor 1304 need not be identical to processor 1306.

Processor 1304 includes an integrated memory controller (IMC) 1320 and point-to-point (P2P) interface 1324 and P2P interface 1328. Similarly, the processor 1306 includes an IMC 1322 as well as P2P interface 1326 and P2P interface 1330. IMC 1320 and IMC 1322 couple the processor 1304 and processor 1306, respectively, to respective memories (e.g., memory 1316 and memory 1318). Memory 1316 and memory 1318 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1316 and the memory 1318 locally attach to the respective processors (i.e., processor 1304 and processor 1306). In other embodiments, the main memory couple with the processors via a bus and shared memory hub. Processor 1304 includes registers 1312 and processor 1306 includes registers 1314.

Computing architecture 1300 includes chipset 1332 coupled to processor 1304 and processor 1306. Furthermore, chipset 1332 are coupled to storage device 1350, for example, via an interface (I/F) 1338. The I/F 1338 may be, for example, a Peripheral Component Interconnect-enhanced (PCIe) interface, a Compute Express Link® (CXL) interface, or a Universal Chiplet Interconnect Express (UCIe) interface. Storage device 1350 stores instructions executable by circuitry of computing architecture 1300 (e.g., processor 1304, processor 1306, GPU 1348, accelerator 1354, vision processing unit 1356, or the like). For example, storage device 1350 can store instructions for the client device 702, the client device 706, the inferencing device 704, the training device 814, or the like.

Processor 1304 couples to the chipset 1332 via P2P interface 1328 and P2P 1334 while processor 1306 couples to the chipset 1332 via P2P interface 1330 and P2P 1336. Direct media interface (DMI) 1376 and DMI 1378 couple the P2P interface 1328 and the P2P 1334 and the P2P interface 1330 and P2P 1336, respectively. DMI 1376 and DMI 1378 is a high-speed interconnect that facilitates, e.g., eight Giga Transfers per second (GT/s) such as DMI 3.0. In other embodiments, the processor 1304 and processor 1306 interconnect via a bus.

The chipset 1332 comprises a controller hub such as a platform controller hub (PCH). The chipset 1332 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1332 comprises more than one controller hub such as a chipset with a memory controller hub, a graphics controller hub, and an input/output (I/O) controller hub.

In the depicted example, chipset 1332 couples with a trusted platform module (TPM) 1344 and UEFI, BIOS, FLASH circuitry 1346 via I/F 1342. The TPM 1344 is a dedicated microcontroller designed to secure hardware by integrating cryptographic keys into devices. The UEFI, BIOS, FLASH circuitry 1346 may provide pre-boot code. The I/F 1342 may also be coupled to a network interface circuit (NIC) 1380 for connections off-chip.

Furthermore, chipset 1332 includes the I/F 1338 to couple chipset 1332 with a high-performance graphics engine, such as, graphics processing circuitry or a graphics processing unit (GPU) 1348. In other embodiments, the computing architecture 1300 includes a flexible display interface (FDI) (not shown) between the processor 1304 and/or the processor 1306 and the chipset 1332. The FDI interconnects a graphics processor core in one or more of processor 1304 and/or processor 1306 with the chipset 1332.

The computing architecture 1300 is operable to communicate with wired and wireless devices or entities via the network interface (NIC) 1380 using the IEEE 802 family of standards, such as wireless devices operatively disposed in wireless communication (e.g., IEEE 802.13 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1354 and/or vision processing unit 1356 are coupled to chipset 1332 via I/F 1338. The accelerator 1354 is representative of any type of accelerator device (e.g., a data streaming accelerator, cryptographic accelerator, cryptographic co-processor, an offload engine, etc.). One example of an accelerator 1354 is the Intel® Data Streaming Accelerator (DSA). The accelerator 1354 is a device including circuitry to accelerate copy operations, data encryption, hash value computation, data comparison operations (including comparison of data in memory 1316 and/or memory 1318), and/or data compression. Examples for the accelerator 1354 include a USB device, PCI device, PCIe device, CXL device, UCIe device, and/or an SPI device. The accelerator 1354 also includes circuitry arranged to execute machine learning (ML) related operations (e.g., training, inference, etc.) for ML models. Generally, the accelerator 1354 is specially designed to perform computationally intensive operations, such as hash value computations, comparison operations, cryptographic operations, and/or compression operations, in a manner that is more efficient than when performed by the processor 1304 or processor 1306. Because the load of the computing architecture 1300 includes hash value computations, comparison operations, cryptographic operations, and/or compression operations, the accelerator 1354 greatly increases performance of the computing architecture 1300 for these operations.

The accelerator 1354 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1354. For example, the accelerator 1354 is shared according to the Single Root I/O virtualization (SR-IOV) architecture and/or the Scalable I/O virtualization (S-IOV) architecture. Embodiments are not limited in these contexts.

Various I/O devices 1360 and display 1352 couple to the bus 1372, along with a bus bridge 1358 which couples the bus 1372 to a second bus 1374 and an I/F 1340 that connects the bus 1372 with the chipset 1332. In one embodiment, the second bus 1374 is a low pin count (LPC) bus. Various input/output (I/O) devices couple to the second bus 1374 including, for example, a keyboard 1362, a mouse 1364 and communication devices 1366.

Furthermore, an audio I/O 1368 couples to second bus 1374. Many of the I/O devices 1360 and communication devices 1366 reside on the system-on-chip (SoC) 1302 while the keyboard 1362 and the mouse 1364 are add-on peripherals. In other embodiments, some or all the I/O devices 1360 and communication devices 1366 are add-on peripherals and do not reside on the system-on-chip (SoC) 1302.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A virtual card number (VCN) management system, comprising:
a processor circuit in data communication with an artificial intelligence (AI) system,
wherein the AI system:
generates one or more VCNs,
provisions, to one or more user devices, each of the one or more VCNs,
monitors a usage of each of the one or more VCNs,
identifies at least one of the one or more VCNs for removal, and
responsive to an identification of at least one of the one or more VCNs for removal, transmits, to at least one of the one or more user devices, a signal to remove the at least one of the one or more VCNs.

2. The VCN management system of claim 1, wherein the identification of at least one of the one or more VCNs for removal is based upon whether the at least one of the one or more VCNs meets a removal setting.

3. The VCN management system of claim 1, wherein the removal setting comprises at least one selected from the group of an allotted number of uses and an allotted spending limit.

4. The VCN management system of claim 3, wherein the allotted number of uses is a single use.

5. The VCN management system of claim 1, wherein the removal setting comprises a predetermined amount of time with no use.

6. The VCN management system of claim 1, wherein the removal setting comprises a predetermined amount of time since the creation of the at least one of the one or more VCNs.

7. The VCN management system of claim 1, wherein the identification of at least one of the one or more VCNs for removal is based upon a user prompt received by at least one of the one or more user devices.

8. The VCN management system of claim 1, wherein the generation of the one or more VCNs is responsive to a user prompt received by at least one of the one or more user devices.

9. The VCN management system of claim 1, wherein the identification of at least one of the one or more VCNs for removal is based upon a prediction generated by the AI system.

10. The VCN management system of claim 1, wherein:
the processor circuit is contained with a server, and
the AI system is stored by the server.

11. The VCN management system of claim 1, wherein:
the processor circuit is contained with a server, and
the AI system is stored externally to the server.

12. A method for virtual card number (VCN) management, comprising:
generating, by an artificial intelligence (AI) system in data communication with a processor circuit, one or more VCNs;
provisioning, by the AI system to one or more user devices, each of the one or more VCNs;
monitoring, by the AI system, a usage of each of the one or more VCNs;
identifying, by the AI system, at least one of the one or more VCNs for removal; and
responsive to an identification of at least one of the one or more VCNs for removal, transmitting, by the AI system to at least one of the one or more user devices, a signal to remove the at least one of the one or more VCNs.

13. The method of claim 12, wherein identifying of at least one of the one or more VCNs for removal comprises:
generating, by the AI system, a prediction, and
identifying, by the AI system, the at least one of the one or more VCNs for removal is based upon the prediction.

14. The method of claim 13, wherein the AI system is trained based on data comprising previous removals of VCNs.

15. The method of claim 14, wherein the data further comprises reasons for previous removals of VCNs.

16. The method of claim 13, wherein the AI system automatically identifies the at least one of the one or more VCNs for removal based on the prediction.

17. The method of claim 12, wherein monitoring the usage of the one or more VCNs comprises periodically scanning a library of provisioned VCNs.

18. The method of claim 12, wherein monitoring the usage of the one or more VCNs comprises continuously scanning a library of provisioned VCNs.

19. A non-transitory computer readable medium comprising instructions implementing an artificial intelligence (AI) system, wherein, when executed by a processor circuit, cause the processor circuit to perform procedures comprising:
generating one or more virtual card numbers (VCNs);
provisioning, to one or more user devices, each of the one or more VCNs;
monitoring a usage of each of the one or more VCNs;
identifying at least one of the one or more VCNs for removal; and
responsive to an identification of at least one of the one or more VCNs for removal, transmitting, to at least one of the one or more user devices, a signal to remove the at least one of the one or more VCNs.

20. The non-transitory computer readable medium of claim 19, wherein identifying of at least one of the one or more VCNs for removal comprises:
generating, by the AI system, a prediction, and
identifying, by the AI system, the at least one of the one or more VCNs for removal is based upon the prediction.
